(19) United States
(12) Patent Application Publication
(10) Pub. No.: US 2011/0055747 A1
(43) Pub. Date: Mar. 3, 2011

(54) Techniques for Expanding Functions of Portable Multimedia Devices

(75) Inventors: Jun Hua, Shenzhen (CN); Dongbo Hao, Shenzhen (CN)

(73) Assignee: NVIDIA CORPORATION, Santa Clara, CA (US)

(21) Appl. No.: 12/650,912

(22) Filed: Dec. 31, 2009

(30) Foreign Application Priority Data
Sep. 1, 2009 (CN) 200910169772.7

(51) Int. Cl. G06F 13/10; G06F 3/048; G06F 13/12

(52) U.S. Cl. 715/771; 710/15; 710/5; 710/74

(57) ABSTRACT

A multifunctional expanding device includes a processing unit, a motherboard (MB), a memory unit, a device interface unit coupled to the MB and communicating with the processing unit for coupling the portable multimedia device to the multifunctional expanding device, and an external interface unit coupled to the MB and communicating with the processing unit for coupling various peripheral devices to the multifunctional expanding device. The processing unit is configured to identify and establish respective communication links between the apparatus and the one or more peripheral devices coupled to the external interface unit; receive a request from the portable multimedia device coupled to the device interface unit for operating a peripheral device coupled to the external interface unit; and establish a communication link between the portable multimedia device and the peripheral device.

### BACKGROUND OF THE INVENTION

With the increasing integration degree of integrated circuits (ICs), more and more device functions can be combined on a single chip. Subsequently, more and more portable multimedia devices, which traditionally have only one single function or a few functions, start to incorporate such multifunctional chips so as to achieve powerful computing and various multimedia processing functions. Such portable multimedia devices include, but not limited to, an intelligent mobile phone, a Personal Digital Assistant (PDA), a Mobile Internet Device (MID), a portable multimedia player (e.g., MP3/MP4 player), a digital camera, a portable game console (e.g., PlayStation®Portable of Sony® Corp.), etc. These portable multimedia devices are similar to a mini Personal Computer (PC) with a powerful Central Processing Unit (CPU), and have functions of computing data and driving various peripheral devices. Therefore, a plurality of applications, such as playing games, downloading and playing music and movies, internet browsing, etc., which were previously only implemented on a conventional PC, can be run on these portable multimedia devices, bringing more and more multimedia experiences along with the portable feature.

Despite of the above advantages, the portability of the portable multimedia devices come with some limitations, which make it difficult to use or to fully perform the various functions that are supported by the processor provided therein. For example, due to the limited screen size and graphic processing ability of a portable multimedia device, only a video with a low resolution can be played, so that the playing effect is far inferior than can be played on a PC or a home theater system. Due to the limited body size of the portable multimedia device, only a few mini interfaces/ports can be provided thereon, which causes inconvenience of communicating with other electronic devices. Similarly, due to a limited power supply by batteries, the portable multimedia device usually cannot provide a long-lasting playing time, especially when playing video games or presenting video clips. These limitations make it difficult for the portable multimedia device to fully utilize its powerful computing ability, resulting in the waste of resources.

For the above reasons, there is a need to develop a multifunctional expanding system for conveniently connecting the portable multimedia device with other peripheral devices, and making full use of the powerful processing ability of the portable multimedia device without the limitations mentioned above.

### SUMMARY OF THE INVENTION

The present technology may best be understood by referring to the following description and accompanying drawings that are used to illustrate embodiment of the present technology. This summary is not intended to identify key features or essential features of the claimed subject matter, nor is it intended to be used as an aid in determining the scope of the claimed subject matter.

In consideration of the above-identified need, a multifunctional expanding system of a portable multimedia device is provided. The multifunctional expanding system primarily comprises an apparatus, i.e. a multifunctional expanding device for connecting the portable multimedia device to various peripheral devices. The apparatus comprises a processing unit, a motherboard (MB) coupled to the processing unit, a memory unit coupled to the MB and in communication with the processing unit, a device interface unit coupled to the MB and in communication with the processing unit, for coupling with the portable multimedia device, and an external interface unit coupled to the MB and in communication with the processing unit, for coupling with various peripheral devices. The processing unit is configured to identify and establish respective communication links between the apparatus and the one or more peripheral devices coupled to the external interface unit; receive a request from the portable multimedia device coupled to the device interface unit for operating a peripheral device coupled to the external interface unit; and establish a communication link between the portable multimedia device and the peripheral device. The memory unit is configured to store program codes and data for use by the processing unit in establishing the communication link between the portable multimedia device and the peripheral device.

According to another aspect of the present invention, a method is provided for use by the multifunctional expending device. The method comprises identifying and establishing respective communication links between the multifunctional expanding device and one or more peripheral devices coupled to an external interface unit of the multifunctional expanding device; receiving a request from a portable multimedia device coupled to a device interface unit of the multifunctional expanding device for operating a peripheral device coupled to the external interface unit; and establishing a communication link between the portable multimedia device and the peripheral device.

Other features and embodiments are described below.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of an exemplary multifunctional expanding device, in accordance with one embodiment of the present technology.

FIG. 2 shows a portable multimedia device coupled to an exemplary multifunctional expanding device, in accordance with one embodiment of the present technology.

FIG. 3 shows is a block diagram of a system setup in which a portable multimedia device is coupled to various peripheral devices through the multifunctional expanding device, in accordance with one embodiment of the present technology.

FIG. 4 shows a flow diagram of an operation method for the multifunctional expanding device, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

The present invention is directed toward portable multimedia devices, and more particularly to a method and an apparatus for expanding functions of the portable multimedia devices. In one embodiment, a multifunctional expanding device includes a device interface for communicating with the portable multimedia device in order to transmit data and signals there between. The multifunctional expanding device also includes a plurality of external interfaces for communication with one or more peripheral devices. The multifunctional expanding device functions as “bridges” between the portable multimedia device and one or more peripheral devices. In this way, the number and type of interfaces of the portable multimedia device can be expanded by the multifunctional expanding device. Furthermore, the multifunctional expanding device may be configured to supply power continuously to the portable multimedia device when they are coupled, in order to ensure a long-lasting operation of the portable multimedia device. When necessary, the multifunctional expanding device may also be provided with an extra processor or a processing unit, such as a Graphic Process Unit (GPU) or an Audio Process Unit (APU). The extra processing unit may cooperate with the CPU of the portable multimedia device to compensate for the insufficient data processing ability, such as graphic or audio data processing ability, of the portable multimedia device.

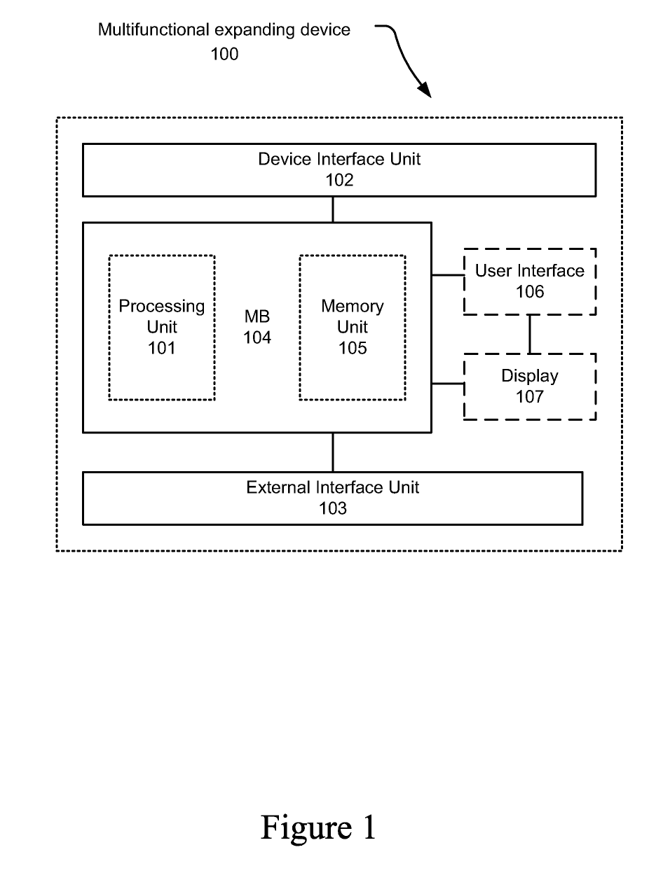

Referring now to FIG. 1, a block diagram of an exemplary multifunctional expanding device 100, in accordance with one embodiment of the present technology, is shown. The multifunctional expanding device 100 includes a processing unit 101, a device interface unit 102, an external interface unit 103, a motherboard (MB) 104 and a memory unit 105. Optionally, the multifunction expanding device 100 may also include a user interface 106 and/or a display unit 107.

The device interface unit 102 is used for coupling a portable multimedia device (not shown) to the multifunctional expanding device 100 and transmitting data and signals there between. The communication channel between the device interface unit 102 and the portable multimedia device may adopt any appropriate protocol commonly known in the art, such as a Universal Serial Bus (USB), a Peripheral Component Interconnect (PCI) port, a Peripheral Component Interconnect Express (PCI-E) port, etc. Preferably, the connection protocol is the PCI-E port. PCI-E is structured around point-to-point serial links, which raises the data transmission rate to a higher level compared with using a PCI or an older shared parallel bus, so that a higher bandwidth than that of a PCI port can be obtained. Compared with PCI, which provides for uni-direction transmission at a single time period, PCI-E uses a dual simplex link to provide higher transmission rate and quality. Furthermore, PCI-E supports hot-plugging, which allows the user to couple or uncouple the portable multimedia device to or from the multifunctional expanding device 100 conveniently. Besides the above-mentioned hardware-based connections, a variety of wireless connections commonly known in the art may also be adopted, such as BlueTooth™ and wireless fidelity (Wi-Fi), etc.

The external interface unit 103 is used for expanding the number and type of the external interfaces for the portable multimedia device. That is to say, the portable multimedia device may couple to various peripheral devices through the multifunctional expanding device 100, whereas a direct connection there between is not possible or performs poorly. The external interface unit 103 may comprise a variety of conventional interfaces commonly used in the art, including, but not limited to, a data transfer port such as Universal Serial Bus (USB), a parallel port, a serial port, an IEEE1394 port, a video and audio port such as a Video Graphics Array (VGA), a High-Definition Multimedia Interface (HDMI), a Super Video (S-Video), an audiovisual (AV), a Digital Visual Interface (DVI) port, a cable or wireless communication port such as local area network (LAN) and wireless fidelity (Wi-Fi) ports or the like. These ports of the external interface unit 103 can be integrated into the MB 104. The peripheral devices to be coupled through the external interface unit 103 include, but not limit to, a computer, an IP visual phone, a digital camera or video camera, a monitor, a memory, an audio/video playback device, a 3D glasses, a keyboard, a mouse, a printer, a projector, a home theater system, an intelligent security control system, a TV cable, a broadband device, a wireless network and other devices.

The MB 104 may adopt any forms or architectures commonly known and used in the art. Preferably, the MB 104 has a high integration degree and thus is small in size, which will make the multifunctional expanding device 100 small. The memory unit 105 may be used to store data that exchange with the portable multimedia device. The memory unit 105 can be used to backup various data of the portable multimedia device, or be used as a supplementary memory when the portable multimedia device has an insufficient memory capacity. The memory unit 105 may adopt any forms and architectures commonly known and used in the art, such as random access memory (RAM), read only memory (ROM), hard disk drives, flash memory, and so on. In consideration of the factors such as stability of operation, high storage capacity, silence and anti-vibration, flash memory is preferred for the memory unit 105.

Compared with the central processor of the portable multimedia device, the processing unit 101 of the multifunctional expanding device 100 may rather act as an assistant processor for the portable multimedia device. Therefore, most of the functions performed by the processing unit 101 may be the functions that the portable multimedia device does not posses or has a lower performance. Taking a mobile phone as an example, the mobile phone may not have sufficient ability in graphic processing and usually does not support three-dimensional (3D) effect. So the processing unit 101 may be configured to implement a powerful graphic processing or 3D effect processing, which compensates for the insufficiency in the graphic processing of the mobile phone. Preferably, the processing unit 101 is a Graphic Processing Unit (GPU), which can optimize graphic data processing, therefore high quality image, such as high definition video or 3D video, can be presented.

The user interface 106 may be used for user control of the peripheral devices or the portable multimedia device that are coupled to the multifunctional expanding device 100. For example, through the user interface 106, a user can send commands to select and turn on or off a particular peripheral device, and adjust operational parameters of the portable multimedia device or the selected peripheral device. Such a user interface unit may be implemented in various ways known in the art, such as an infrared (IR) transceiver or a radio frequency (RF) transceiver, which receives user inputs from a handheld remote control device.

The display unit 107 may be a light emitting diode (LED) display or liquid crystal (LC) display or any other display method known in the art. The multifunctional expanding device 100 may employ the display unit 107 for displaying a status indicator indicating the working status of the multifunctional expanding device 100 and/or the peripheral devices, or, used in conjunction with the user interface 106, the display unit 107 may display a user menu or the like for the remote controlling (or any other kind of user controlling) by the user.

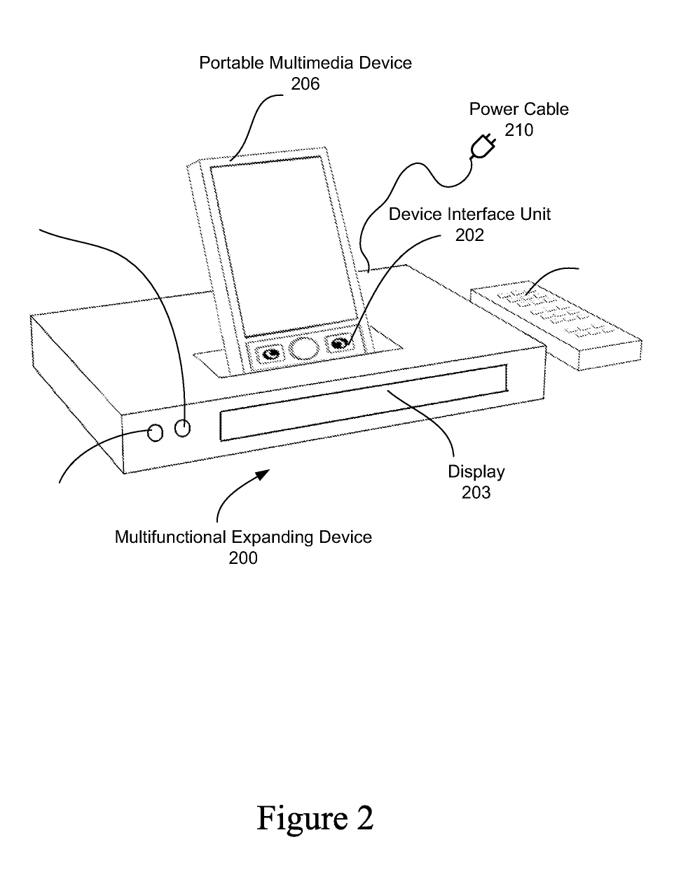

Referring now to FIG. 2, an exemplary multifunctional expanding device 200 coupled to a portable multimedia device 206, in accordance with one embodiment of the present technology, is shown. In this example, the multifunctional expanding device 200 is encased in a housing structure 201, forming a standing unit. The device interface unit of the multifunctional expanding device 200 is implemented as a slot 202 on the top surface of the housing 201 for receiving the portable multimedia device 206 physically thereon. This standing unit may be a conventional design, similar to a stand for an iPod of the Apple Company or a conventional mobile phone charging station. Not only can this device interface unit embedded in the slot 202 transmit data and signals between the portable multimedia device 206 and the multifunctional expanding device 200, but also position the portable multimedia device 206 firmly on the top of the housing 201. Furthermore, under the situation that the connection between the portable multimedia device 206 and the multifunctional expanding device 200 is a hardware connection, the multifunctional expanding device 200 may be configured to supply power to or charge the portable multimedia device 206 through the device interface unit. Power supply and charging may be performed using the AC/DC power supply through a wall plug and a cable 210 or a battery installed inside the housing 201. The function of power supply and charging ensure the portable multimedia device 206 to operate for a long time even under a high power consuming mode, which avoids the interruptions caused by the power exhausting of the portable multimedia device 206.

Besides the power supply function, the housing 201 may include other slots or ports for the external interface unit of the multifunctional expanding device 200 to be coupled with one or more peripheral devices (not shown). For example, an audio jack 204 may be provided for coupling external speakers to the multifunctional expanding device 200.

Further, the multifunctional expanding device 200 may include a user interface for a user to select the peripheral devices or control the operational parameters of the peripheral devices through the multifunctional expanding device 200. For example, such a user interface unit may be implemented as an infrared port 205, which receives user inputs from a handhold remote control 207.

Still further, for more sophisticated user controlling, the multifunction expanding device 200 may include a digital display 203 for displaying a menu or the like to be used in conjunction with the remote controlling (or any other kind of user controlling) through the user interface.

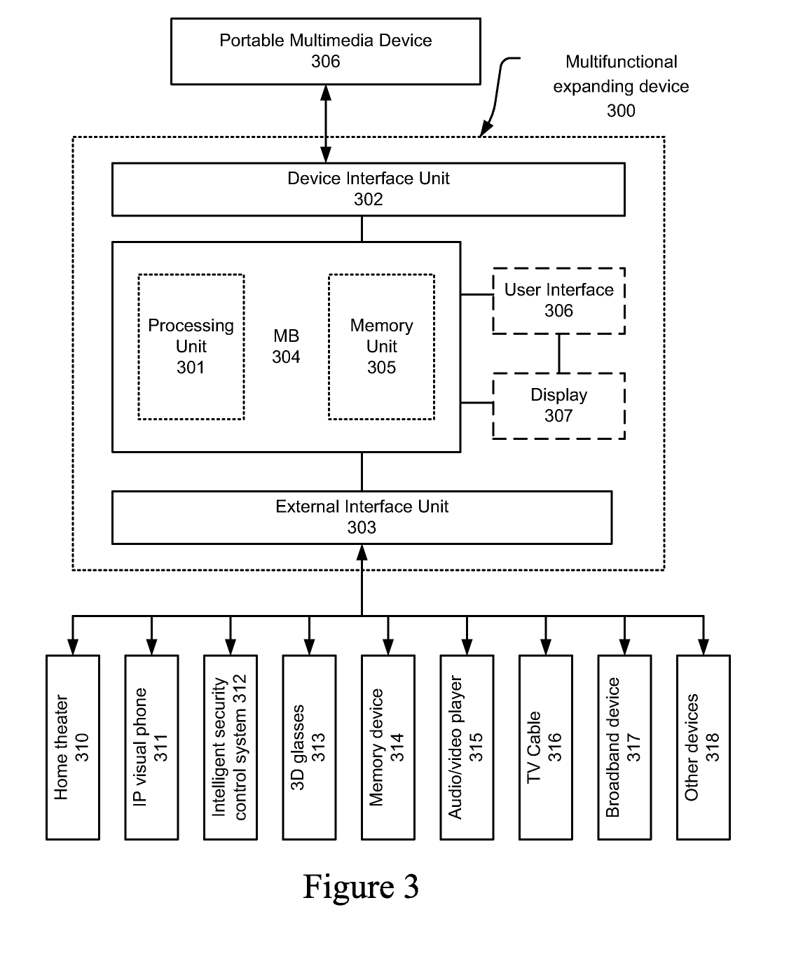

Referring now to FIG. 3, a block diagram of a system in which a portable multimedia device 306 is coupled to various peripheral devices 310-318 through the multifunctional expanding device 300, in accordance with one embodiment of the present technology, is shown. The multifunctional expanding device 300 includes a processing unit 301, a device interface unit 302, an external interface unit 303, a motherboard (MB) 304 and a memory unit 305. Optionally, the multifunctional expanding device 300 may also include a user interface 306 and a display unit 307. The architecture and functions of these units have been described with reference to FIG. 1 as above. In the illustrated system, at one end, a portable multimedia device 306 is coupled to the multifunctional expanding device 300 through a PCI-E or a USB port provided in the device interface unit 302 to transmit data and signals there between. The multifunctional expanding device 300 may also supply power to and/or charge the portable multimedia device 306 through the connecting port at the same time. At another end, one or more peripheral devices 310-318 may be coupled to the multifunctional expanding device 300 through the respective interfaces/ports configured on the external interface unit 303. The peripheral devices include, but are not limited to, a home theater system 310, an Internet protocol (IP) visual phone 311, an intelligent security control system 312, a 3D glasses 313, a memory device 314, an audio/video player 315, a TV signal cable 316, a broadband device 317 and/or other devices 318. The functions of these peripheral devices connected with the multifunctional expanding device 300 and portable multimedia device 306 will be discussed in the following.

The processing unit 301 and the memory unit 305 of the multifunctional expanding device 300 are configured to (1) execute applications and drivers that enhance or expand the functions of the portable multimedia device 306 through the coupled peripheral devices, and (2) store program codes and data, respectively. In other words, the processing unit 301 runs a process in order to build proper communicating connections between the portable multimedia device 306, the multifunctional expanding device 300 and one or more of the peripheral devices 310-318. For example, drivers of various peripheral devices, such as drivers for monitors, printers, mobile phones, PDAs, IP visual phones or 3D glasses, can be installed on the multifunctional expanding device 300 and be executed by the processing unit 301. One instance is that when the portable multimedia device 306 is coupled to the multifunctional expending device 300 which has been coupled to peripheral devices, under the assistance of the multifunctional expanding device 300, the portable multimedia device 306 detects and identifies the communication channel to the peripheral devices so that it starts to use the communication channel for signal exchanges between the portable multimedia device 306 and the peripheral devices.

In another instance, a user of the system may select whether to use the peripheral devices, to select which peripheral devices to use (when multiple devices are connected), or to configure or operate the peripheral devices. This can be done through the portable multimedia device 306 or through the multifunctional expanding device 300. For example, when a monitor is connected to the multifunctional expanding device 300, the corresponding monitor driver installed on the multifunctional expanding device 300 will identify the monitor automatically and then build a connection between the portable multimedia device 306 and the monitor. Then the user may select whether to use the monitor through the portable multimedia device 306. The user may use the portable multimedia device 306 to send a signal to the multifunctional expanding device 300 to enable or disable the monitor. If the user chooses to use the monitor, then the portable multimedia device 306 will transmit data to the monitor through the multifunctional expanding device 300. Also, the parameters of the monitor such as chromaticity, contrast, etc. can be configured through the portable multimedia device 306. Another example is when a 3D set of glasses is connected to the multifunctional expanding device 300, the user may choose to use the 3D glasses to watch the 3D image shown on the monitor, or the user may choose not to activate the 3D glasses and watch the video directly.

It is obvious that the procedures mentioned above may be performed automatically. That is to say, whenever the peripheral devices are connecting to the multifunctional expanding device 300, the peripheral devices will be activated automatically. For better understanding the present invention, the process for the portable multimedia device 306 and the multifunctional expanding device 300 to identify and use the peripheral devices is similar to that for a traditional PC.

Alternatively, in case the user control of the peripheral devices through the portable multimedia device 306 is not possible or inconvenient, the user may use the optional user interface 306 of the multifunctional expanding device 300 to perform the control functions. The optional display unit 307 may be used to indicate the commands and selections input by the user.

A remote control unit may be provided to the system for convenient usage. Such a remote control has been shown in FIG. 2 described above. The connection between the remote control and the system is usually via a wireless communication channel, such as a conventional IR connection or a RF connection such as Bluetooth™. Users can use the remote control unit to control the peripheral devices coupled with the multifunctional expanding device 300. This can be done by: (1) controlling the portable multimedia device 306, so it sends a control signal to the multifunctional expanding device 300 and the multifunctional expanding device 300 sends instructions to the peripheral devices; (2) controlling the multifunction expanding device 300, so it sends instructions to the peripheral devices; or (3) controlling the peripheral devices directly. For example, when a monitor is coupled to the multifunctional expanding device 300, the remote control can be used to adjust the brightness or contrast of the monitor; when a speaker is coupled, the remote control can be used to adjust the volume, and so on. In other words, the remote control may replace the portable multimedia device 206 as a controlling means to operate the peripheral devices conveniently.

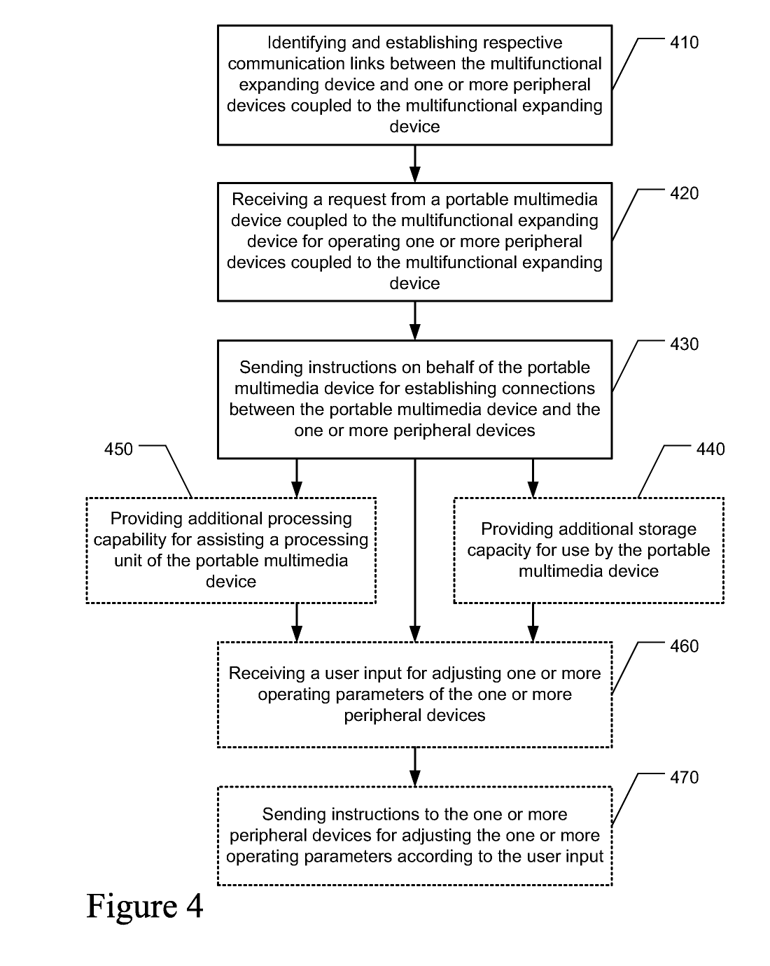

Referring now to FIG. 4, a flow diagram of a method for use by the multifunctional expending device, in accordance with one embodiment of the present technology, is shown. At 410, the multifunctional expending device identifies and establishes respective communication links between the multifunctional expanding device and one or more peripheral devices coupled to the external interface unit of the multifunctional expanding device. At 420, the multifunctional expanding device receives a request from the portable multimedia device coupled to the device interface unit of the multifunctional expanding device for operating a peripheral device coupled to the external interface unit. At 430, the multifunctional expanding device establishes a communication link between the portable multimedia device and the peripheral device.

Optionally, at 450, the multifunctional expanding device provides additional processing capability for assisting a processing unit of the portable multimedia device. Or, at 460, the multifunctional expanding device provides additional storage capacity for use by the portable multimedia device.

The multifunctional expanding device may, at 460, receive a user input for adjusting one or more operating parameters of the peripheral device. Thereafter, at 470, it sends instructions to the peripheral device for adjusting one or more operating parameters according to the user input. Some exemplary applications of the multifunctional expanding device according to the present invention are introduced below.

### Exemplary Embodiment 1

### Connecting the Portable Multimedia Device to a Home Multimedia Center

At present, home multimedia centers (a.k.a. home theaters) are widely used by families due to their powerful audio/visual functions. A home multimedia center typically includes a large screen size television, a projector and an audio reproducing system. Due to the small size screen of the portable multimedia device and the poor ability in graphic processing and audio playing, a user's experience of the multimedia resources carried by the portable multimedia device may be limited. Therefore, the portable multimedia device is preferably coupled to the home multimedia center through the multifunctional expanding device according to the present invention, so that the video and audio recourses on the portable multimedia device can be played in a better performance through the large size screen and the excellent audio reproducing system of the home multimedia center. Provided with a separate GPU on the multifunctional expanding device, high definition video or 3D video that cannot be played or smoothly played on the portable multimedia device now can be played on the home multimedia center through the multifunctional expanding device according to the present technology. Thus, not only can a better effect than playing on the portable multimedia device be obtained, but also the insufficiency of the portable multimedia device in functions will be compensated.

The connection between the multifunctional expanding device according to the present invention and the home multimedia center can be configured depending on the type of the interfaces of the peripheral devices. For example, when a projector is connected, an AV port or an S-Video port can be used; when a monitor is connected, a VGA port or a DVI port can be used. Preferably, an HDMI port is used for realize the connection since the HDMI port can transmit audio and video signals at the same time. It is understood that any connections that can transmit signal and data can be used in order to meet different requirements.

It should be noted that concerning the multiple functionality, the combination of the portable multimedia device and the multifunctional expanding device is more or less like a traditional Home Theater Personal Computer (HTPC). For example, powerful audio and video processing and reproducing ability can be achieved through the processors of the portable multimedia device and the multifunctional expanding device, and a large storage capacity can be obtained by the memory of the multifunctional expanding device according to the present invention. However, there is an advantage in the present invention that the multifunctional expanding device is much more convenient and economy than the traditional HTPC.

In addition, since the portable multimedia device may be configured with some functions such as downloading data from the Internet, shooting pictures and moving from one system to another, it can obtain various multimedia resources through various channels. In this way, the portable multimedia device can also be a multimedia resource for the home multimedia center. For example, with the popularization of the 3G high speed network, people like to use mobile phones to download and play real-time audio and video. The mobile phones can be coupled to the home multimedia center through the multifunctional expanding device according to the present invention, so that the real-time playing can be performed on the home theater.

### Exemplary Embodiment 2

### Accessing Intelligent Security Control System Through the Portable Multimedia Device

With the increasing needs of the security control system by the enterprises and the communities, home intelligent security control system will replace the traditional measures such as weld mesh screens. The home intelligent security control system is a new intelligent control system based on the integration of computer technology, network technology and control technology. A lot of functions can be achieved through this system, such as alarming (anti-thief alarm, gas leak alarm, fire alarm, and emergency alarm, etc.), remote control, timing control, calling the police by phone and voice prompt. With the present invention, users may control the intelligent security control system through a portable multimedia device when the intelligent security control system is coupled (e.g., through RF LAN or the Internet) to the multifunctional expanding device. Therefore, the above-mentioned functions can be realized easily under the control of the portable multimedia device. For example, a user may use a mobile phone to monitor or shout to the security control spot, or watch the security control spot through the real-time video and switch to different cameras, which facilitate the control of the security control system. A monitor can be coupled to the multifunctional expanding device and the image in the security control system may be transmitted to the monitor through the multifunctional expanding device to obtain a better view. Also, the image in the security control system may be uploaded to the Internet through the networking functions of the multifunctional expanding device according to the present invention, so that user can check the security spot at any place or any time.

### Exemplary Embodiment 3

### Connecting the Multifunctional Expanding Device to a Visual-IP-Phone

With the increasing network bandwidth, use of Internet Protocol (IP) phone technology is becoming increasingly popular. IP phone is a brand-new communication service in accordance with the Internet technology content of the international Internet protocol and using the Internet as voice transmission media to perform voice communication. A variety of software applications such as Skype™ have appeared to allow users making voice telephone calls over the Internet, sending instant messages, transferring files and video conferencing with one another. Not only may a user receive calls from other users via their computers, which is currently free-of-charge, but also call regular phones and mobile phones world wide at much less cost than using conventional telephones.

Since the multifunctional expanding device according to the present invention has the networking function, a portable multimedia device may be coupled to the Internet through the multifunctional expanding device, and IP phone software installed on the multifunctional expanding device may be run to realize communication through the IP phone. User can use the portable multimedia device to make IP phone calls, which is cheaper than using regular phone but having almost same communication quality. Furthermore, the camera and screen of the portable multimedia device can be used to perform visual phone functions through the multifunctional expanding device.

### Exemplary Embodiment 4

### Connecting the Multifunctional Expanding Device to 3D Glasses

3D films and games are becoming more and more popular, and they bring different visual experiences to users. Watching a 3D image needs a specific device called 3D glasses, such as GeForce 3D Vision from NVIDIA. With the present technology, a user may use the portable multimedia device to drive the 3D glasses in order to watch 3D image by coupling the 3D glasses to the multifunctional expanding device. The 3D glasses includes a 3D synchronizer provided with an interface (e.g., a USB port), which can be used to couple to the multifunctional expanding device and further to the portable multimedia device. The connection between the 3D synchronizer and the glasses may be via wireless means, e.g., an infrared port.

Considering the fact that some portable multimedia devices may not support the 3D effect, the processing unit (e.g., GPU) provided inside the multifunctional expanding device may be configured to support the 3D effect.

### Exemplary Embodiment 5

### Providing Cable TV Access to the Portable Multimedia Device

Watching TV on the portable multimedia device such as a mobile phone is becoming a new way of entertainment. However, the TV signals are usually unsteady due to the limited ability of receiving TV signals directly by the portable multimedia device, and the video effect shown on the portable multimedia device is also limited by the graphic processing ability and the small screen size of the portable multimedia device. With the present technology, the multifunctional expanding device may function as a Set-Top Box (STB). That is, a TV cable may be coupled to the multifunctional expanding device and it transmits the data to be processed by the portable multimedia device. In this way, a steady TV signal may be transmitted to the portable multimedia device and some complex graphic processes such as High Definition reproduction may be obtained through the portable multimedia device.

As stated above, through the multifunctional expanding device of the present technollgy, not only can users couple the portable multimedia device to various peripheral devices, but also process and optimize data transmitted to or received from the portable multimedia devices by the processing unit of the multifunctional expanding device. Therefore, the inconvenience brought by the limitations of the portable multimedia devices is drastically decreased, and the functions and performance of the portable multimedia devices are largely expanded.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A multifunctional expanding apparatus for a portable multimedia device, comprising:
a processing unit;
a motherboard to which the processing unit is connected;
a memory unit coupled to the motherboard and in communication with the processing unit;
a device interface unit, coupled to the motherboard and in communication with the processing unit, for coupling with said portable multimedia device; and
an external interface unit, coupled to the motherboard and in communication with the processing unit, for coupling with one or more peripheral devices;
wherein the processing unit is configured to:
identify and establish respective communication links between the apparatus and the one or more peripheral devices coupled to the external interface unit;
receive a request from the portable multimedia device coupled to the device interface unit for operating a peripheral device coupled to the external interface unit; and
establish a communication link between the portable multimedia device and the peripheral device.

2. The multifunctional expanding apparatus of claim 1, wherein the processing unit is further configured to:
provide additional processing capability for assisting a processing unit of the portable multimedia device.

3. The multifunctional expanding apparatus of claim 1, wherein the memory unit is further configured to:
provide additional storage capacity for use by the portable multimedia device.

4. The multifunctional expanding apparatus of claim 1, further comprising:
a user interface, wherein the user interface is configured to receive a user input for adjusting one or more operating parameters of the peripheral device; and wherein the processing unit is further configured to send instructions to the peripheral device for adjusting the one or more operating parameters according to the user input.

5. The multifunctional expanding apparatus of claim 4, further comprising display means for indicating status of the apparatus or the one or more peripheral devices coupled with the apparatus, or for use with the user interface.

6. The multifunctional expanding apparatus of claim 1, wherein the portable multimedia device is selected from a group consisting of a mobile phone, a personal data assistant (PDA), a multimedia player, a digital camera and a game console.

7. The multifunctional expanding apparatus of claim 1, wherein the processing unit is a graphic process unit (GPU) or an audio process unit (APU).

8. The multifunctional expanding apparatus of claim 1, wherein the memory unit is selected from a group consisting of a random access memory (RAM), a read only memory (ROM), a hard disk drive, and a flash memory.

9. The multifunctional expanding apparatus of claim 1, wherein the device interface unit is selected from a group consisting of a peripheral component interconnect express (PCI-E) port, a universal serial bus (USB) port, a Bluetooth™ interface, an infrared port and a wireless fidelity (WiFi) interface.

10. The multifunctional expanding apparatus of claim 1, wherein the apparatus is encased in a housing structure to form a standing unit, said housing structure comprises a slot with the device interface unit formed thereon for receiving the portable multimedia device.

11. The multifunctional expanding apparatus of claim 1, wherein the external interface unit comprises one or more of the following: a universal serial bus (USB) port, a parallel port, a serial port, an IEEE1394 port, a video graphics array (VGA), a high-definition multimedia interface (HDMI), a super video (S-Video) connection, an audiovisual (AV) connection, a digital visual interface (DVI) port, a local area network (LAN) node, a wireless fidelity (Wi-Fi), an infrared port and 3D glasses port.

12. The multifunctional expanding apparatus of claim 1, wherein the peripheral device is selected from a group consisting of a keyboard, a mouse, a monitor, a printer, a microphone, a speaker, a camera, a home theater, an IP visual phone, an intelligent security control system, a 3D glasses, a memory device, an audio/video player and a TV cable.

13. The multifunctional expanding apparatus of claim 1, wherein the apparatus is configured to supply power to and/or charge the portable multimedia through the device interface unit.

14. A method for use by a multifunctional expending device, comprising:
identifying and establishing respective communication links between the multifunctional expanding device and one or more peripheral devices coupled to an external interface unit of the multifunctional expanding device;
receiving a request from a portable multimedia device coupled to a device interface unit of the multifunctional expanding device for operating a peripheral device coupled to the external interface unit; and
establishing a communication link between the portable multimedia device and the peripheral device.

15. The method of claim 14, further comprising:
providing additional processing capability for assisting a processing unit of the portable multimedia device.

16. The method of claim 14, further comprising:
providing additional storage capacity for use by the portable multimedia device.

17. The method of claim 14, further comprising:
receiving a user input for adjusting one or more operating parameters of the peripheral device; and
sending instructions to the peripheral device for adjusting one or more operating parameters according to the user input.

18. A computer program product comprising a computer readable storage media storing program codes thereon for use by a multifunctional expanding device, said product comprises:
program codes for identifying and establishing respective communication links between the multifunctional expanding device and one or more peripheral devices coupled to an external interface unit of the multifunctional expanding device,
program codes for receiving a request from a portable multimedia device coupled to a device interface unit of the multifunctional expanding device for operating a peripheral device coupled to the external interface unit, and
program codes for establishing a communication link between the portable multimedia device and the peripheral device.

19. The computer program product of claim 18, further comprising:
program codes for providing additional processing capability for assisting a processing unit of the portable multimedia device.

20. The computer program product of claim 18, further comprising:
program codes for receiving a user input for adjusting one or more operating parameters of the peripheral device, and
program codes for sending instructions to the peripheral device for adjusting one or more operating parameters according to the user input.
